(19) United States
(12) Patent Application Publication
(10) Pub. No.: US 2007/0021308 A1
(43) Pub. Date: Jan. 25, 2007

(54) Composition and method for fracturing subterranean reservoirs

(76) Inventors: Paul Berger, Sugar Land, TX (US); Christie Huimin Berger, Sugar Land, TX (US)

Correspondence Address: PAUL BERGER;c/o OCT, 12822 PARK ONE DRIVE, SUGAR LAND, TX, 77478, US

(21) Appl. No.: 11/516,246

(22) Filed: Sep. 6, 2006

Related U.S. Application Data
(62) Division of application No. 10/818,849, filed on Apr. 6, 2004.

(51) Int. Cl. C09K 8/60

(52) U.S. Cl. 507/211

(57) ABSTRACT

A method for fracturing subterranean reservoirs by including a partially esterified, polyalkoxylated polyols as an oxidizing breaker retarder in the aqueous fracturing fluid to delay its gel breaking properties with the oxidizing breaker. The delayed gel breaking properties will lead to the controlled breaking of the fracturing fluid that reduces or eliminates damage to the formation and facilitates well clean up.

This patent is a divisional of U.S. patent application Ser. No. 10/818849 filed Apr. 6, 2004 and published as US Patent Application Publication 2005/0227874 on Oct. 13, 2005.

### FIELD OF INVENTION

This invention relates to a fracturing fluid composition containing an oxidizing breaker retarder and a method for fracturing subterranean reservoirs using such fracturing fluid composition.

### BACKGROUND—DESCRIPTION OF PRIOR ART

Hydraulic fracturing is a technique commonly utilized to stimulate the production of oil and gas from subterranean formations of low permeability. In carrying out such techniques, the fracturing fluid is introduced into the formation under hydraulic pressure to produce one or more fractures in the target formation. The fluid can include proppants that are deposited in the fractures so that when the pressure against the formation is relaxed, the proppants maintain the fracture in an open or propped condition.

Upon completion of the treatment, it is generally desirable to remove the gelled fracturing fluid from the formation. To effectively remove the fluid, the viscosity of the fluid must be reduced. The reduction of the viscosity of the gelled fluid is referred to as “breaking” the gel. The agent responsible for breaking the gel is referred to as a “gel breaker”. Traditional gel breakers include enzymes and oxidizing breakers. The breaker can comprise substantially any of the well known oxidizing breakers. Examples of oxidizing breakers include ammonium persulfate, sodium persulfate, potassium persulfate, sodium peroxide, sodium chlorite, sodium, lithium or calcium hypochlorite, potassium perphosphate, sodium perborate and the like.

At formation temperatures of between about 75° F. to about 120° F., and pH ranges of about 4 to 9, enzyme breakers are suitable. At temperatures above 120° F., the enzyme breakers are inadequate and oxidizing breakers are required. Generally, depending upon the temperature of the formation, between about 0.1 and 5.0 pounds of the oxidizing breaker(s) per 1000 gallons of aqueous gel is sufficient to break the gel. However, problems caused by insufficient breaking or the breaking of the fluid too quickly are often experienced with the oxidizing breakers. Ideally, a fracturing fluid has high initial viscosity that remains stable during the well treatment and controlled breaking after the treatment. Heretofore, the control of breaking of the gel has been inadequate resulting in less than desirable treatment results.

There have been several proposed methods for the delayed breaking of the fracturing fluid that were aimed at eliminating the above problems. U.S. Pat. No. 4,968,442 and U.S. Pat. No. 5,010,954 use various concentrations of ethylenediamine-tetraacetic acid (EDTA) to break gels to a predetermined degree. One advantage claimed in this disclosure is that gels can be broken to different degrees thus controlling the flow-back characteristics of the fracture. U.S. Pat. No. 4,202,795 uses persulfate or fumaric acid or enzyme breaker encapsulated in a prill composed of a hydrolyzable gel to delay the release of said breakers as well as other additives such as demulsifiers that may be included in the prill. U.S. Pat. No. 5,497,830 uses gel breakers coated with a water insoluble wood resin to reduce the rate of release of breaker. U.S. Pat. No. 5,437,331 uses an enzyme encapsulated in a polymeric material such as polymethylmethacrylate (PMMA) to delay the enzymatic breaking of the gel. U.S. Pat. No. 5,393,810 uses sequestering agents such as copolymers of vinylpyrrolidone and acrylic acid to reduce the gel breaking effectiveness of the oxidizer.

Other delayed oxidizing gel breakers and techniques have been used previously. These include enclosing the breaker within a slowly dissolving or slowly melting capsule. The disadvantages of this approach are 1) the technique is expensive and 2) the melting and dissolving mechanism is dependent on the treatment and formation conditions. If the temperature is not high enough the capsules will not dissolve or melt.

In spite of all this technology, there still remains a need for a composition and method for the controlled breaking of the fracturing gel that is economical and effective and reduces or eliminates damage to the formation and facilitates well clean up.

In U.S. Pat. No. 6,617,285, polyols are used to accelerate the enzymatic breaking of borate crosslinked gels. Unexpectedly, as will be shown later, we have found that if these polyols and other polyols are partially esterified they actual serve to retard the breaking process of the oxidizing breaker(s), thus rendering it more controllable.

U.S. Pat. Nos. 3,88,312 and 4,137,182 describe fracturing fluids and their application but do not employ polyols as breaker retarding agents.

### BRIEF DESCRIPTION OF THE INVENTION

The present invention relates to fracturing fluid compositions containing an oxidizing breaker retarder and a method for fracturing subterranean reservoirs using such fracturing fluid compositions.

The fracturing fluid compositions include gelling agent(s), cross-linker(s), oxidizing breaker(s), pH control agent(s), and other desirable additives that comprise gelled fluids and that are known in the art. In addition the fracturing fluids contain unique oxidizing breaker retarders. The oxidizing breaker retarders are partially esterified, polyalkoxylated polyols that moderate the effect of the oxidizing breaker(s) according to their concentrations, the well treating conditions and also by varying the degree of esterification and the degree of alkoxylation of the partially esterified, polyalkoxylated polyols. By the present invention and the inclusion of partially esterified, polyalkoxylated polyols in aqueous fracturing fluid formulations as oxidizing breaker retarders, the gel breaking time can be controlled.

### DETAILED DESCRIPTION OF THE INVENTION

The composition and method of the present invention is directed to the fracturing of subterranean formations using gelled aqueous fracturing fluids. The present invention includes a partially esterified, polyalkoxylated polyol(s) as the oxidizing breaker retarder in the gelled aqueous fracturing fluid composition.

The preferred gelled fracturing fluid composition includes a hydratable gelling agent, an aqueous liquid, an oxidizing breaker and partially esterified, polyalkoxylated polyols as oxidizing breaker retarder. Optionally, pH control agents, such as potassium carbonate and the like, may be used to adjust and control the pH. Also crosslinking agents are usually necessary to improve the gel characteristics of the polymer used. Also proppants are usually included to assist in keeping the fractures open.

The gelling agents include hydratable polymers, which contain, in sufficient concentration and reactive position, cis-hydroxyl, carboxyl, sulfate, sulfonate, amino or amide. Particularly suitable polymers are polysaccharides and derivatives thereof, which contain one or more of the following monosaccharide units: galactose, mannose, glucoside, glucose, xylose, arabinose, fructose, glucuronic acid or pyranosyl sulfate. Natural hydratable polymers containing the foregoing functional groups and units include guar gum and derivatives thereof, locust bean gum, tara, konjak, tamarind, starch, cellulose and derivatives thereof, karaya, xanthan, tragacanth and carrageenan.

Hydratable synthetic polymers and copolymers which contain the above-mentioned functional groups and which can be utilized in accordance with the present invention include, but are not limited to, polyacrylate, polymethacrylate, polyacrylamide, maleic anhydride methylvinyl ether copolymers, polyvinyl alcohol and polyvinylpyrrolidone.

The aqueous liquid may include water, a sodium chloride brine solution, a potassium chloride solution, water-alcohol mixtures and the like. The hydratable polymer and aqueous liquid are preferably prepared by combining the polymer with the aqueous liquid in an amount in the range of from about 5 to about 80 pounds of polymer per 1,000 gallons of aqueous liquid.

Preferably, after combining the aqueous liquid with the gelling agent, the gelling agent may be crosslinked by the addition of sufficient quantities of a crosslinking agent. Typical crosslinking agents include, for example, boron, titanium, antimony, zirconium, and aluminum. The amount of crosslinking agent added to the hydrated gelling agent may depend upon several factors, such as for example, the type and quantity of polymer present in the aqueous liquid, such surface conditions to be encountered by the crosslinked gel system, and the purpose for which the crosslinked gel system is to be used, i.e. gel pad, fracturing, graveling packing, etc. These and other factors are appreciated and well known by those skilled in the art of preparing crosslinked gel systems, and therefore sufficient quantities of crosslinking agent are readily determinable.

Proppants may be selected from sand, resin coated sand, synthetic ceramics, spherical pellets of glass and the like, as commonly used in the aqueous fracturing processes.

The breaker can comprise substantially any of the well known oxidizing breakers. Examples of breakers include ammonium persulfate, sodium persulfate, potassium persulfate, sodium peroxide, sodium chlorite, sodium, lithium or calcium hypochlorite, potassium perphosphate, sodium perborate and the like. The breaker generally will be admixed with the gelled aqueous liquid in an amount of from about 0.1 to about 10 pounds per 1000 gallons of aqueous gel and preferably, from about 0.1 to about 0.5 pounds per 1000 gallons of aqueous fluid depending on the preferred gel break time.

The oxidizing breaker retarder can be any of a number of partially esterified, polyalkoxylated polyols. These include, but are not limit to, mono and higher esters of alkoxylated sorbitol, alkoxylated mono and disaccharides such as glucose, fructose, and sucrose, alkoxylated glycerine, alkoxylated polyglycerine, alkoxylated pentaerythritol, or alkoxylated trimethylolpropane any of which have been alkoxylated with ethylene oxide (POE), propylene oxide (POP) and butylene oxide (POB) or mixtures of one or more POE, POP, POB.

The amount of oxidizing breaker retarder used is determined by several factors, including the degree of delayed break required, the temperature, the amount of oxidizing breaker present, the nature and the amount of crosslinked polymer present in the aqueous fracturing fluid. Generally the amount of oxidizing breaker retarder used is from about 0.1 to about 20 gallons, and preferably from about 1.0 to about 10 gallons per 1000 gallons.

In the preferred method, the aqueous fracturing fluid is pumped downhole, under pressure, to cause one or more fractures in the reservoirs. After the fractures have been formed the gel is broken and the aqueous fracturing fluid is withdrawn from the reservoir.

### EXAMPLES

The effectiveness of the partially esterified, polyalkoxylated polyols as oxidizing breaker retarders was determined for a crosslinked guar gum system. The crosslinked gel system contained 40 lbs per 1000 gallons of the guar gum, 10 lbs per 1000 gallons of the potassium carbonate and 1 lb per 1000 gallons of the borate crosslinking agent. 0.125 lbs per 1000 gallons of the Na₂S₂O₈ was added to the crosslinked gel as the oxidizing breaker. Different amounts of the POE(30) sorbitol trioleate, which is sorbitol reacted with 30 moles of ethylene oxide and then esterified with 3 moles of oleic acid, were added as the oxidizing breaker retarder.

The samples were set in a 140° F. oven and the viscosity was measured after 0.5, 1, 2, and 3 hours. The data in Table 1 indicates that the POE(30) Sorbitol Trioleate retards the gel breaking rate of the oxidizing breaker. Using the same oxidizing breaker concentration, the time required for the gel to break is increased by increasing the amount of POE(30) Sorbitol Trioleate. The sample without any oxidizing breaker remained a complex gel after 3 hours at 140° F. The sample with the oxidizing breaker but without any POE(30) Sorbitol Trioleate was reduced from complex gel to 7 cps in 2 hours. Samples containing different amounts of POE(30) Sorbitol Trioleate demonstrated retarded viscosity breaking proportional to the amount of POE(30) Sorbitol Trioleate added

TABLE 1
VISCOSITY (cps) @ 140° F.

| Sample | 0.5 hr | 1.0 hr | 2.0 hr | 3.0 hr |
|---|---|---|---|---|
| 1 | C | C | C | C |
| 2 | C | WC | 7 | B |
| 3 | C | C | 14 | B |
| 4 | C | C | 47 | 4 |
| 5 | C | C | C | 35 |

Note:
Sample No. 1: Control, crosslinked guar gum system only
Sample No. 2: crosslinked guar gum system + oxidizing gel breaker
Sample No. 3: crosslinked guar gum system + oxidizing gel breaker + 2 gal/1000 gal POE(30) Sorbitol Trioleate as oxidizing breaker retarder
Sample No. 4: crosslinked guar gum system + oxidizing gel breaker + 5 gal/1000 gal POE(30) Sorbitol Trioleate as oxidizing breaker retarder
Sample No. 3: crosslinked guar gum system + oxidizing gel breaker + 10 gal/1000 gal POE(30) Sorbitol Trioleate as oxidizing breaker retarder
C = Complexed Gel
WC = Weak Complexed Gel
B = Broke

Table 2 shows the effect of the degree of esterification and the degree of ethoxylation on the oxidizing gel breaker retardation. Different samples were prepared using sorbitol reacted with from 20 to 40 moles of ethylene oxide and then esterified with from 0 to 6 moles of oleic acid. The crosslinked gel system contained 40 lbs per 1000 gallons of the guar gum, 10 lbs per 1000 gallons of potassium carbonate, 1 lb per 1000 gallons of the borate crosslinking agent, 0.125 lbs per 1000 gallons of the Na₂S₂O₈, and 2.0 gallons per 1000 gallons of various partially esterified, polyalkoxylated polyols. The viscosity was measured after 1 hour at 140° F. by the visual judgment system as described in U.S. Pat. No. 5,393,810.

TABLE 2
EFFECT OF DEGREE OF ESTERIFICATION/ALKOXYLATION
ON OXIDIZING GEL BREAKER RETARDATION

| Moles | | | | | | | |
|---|---|---|---|---|---|---|---|
| Acid/EO | 20 | 24 | 26 | 28 | 30 | 36 | 40 |
| 0 | B | B | B | B | B | B | B |
| 1 | B | B | B | WC | MC | WC | B |
| 2 | B | B | WC | MC | SC | MC | B |
| 3 | B | WC | MC | SC | SC | MC | B |
| 4 | B | B | WC | MC | SC | SC | B |
| 5 | B | B | B | WC | MC | MC | B |
| 6 | B | B | B | B | B | WC | B |

NOTE:
B = Broke
WC = Weak Complex
MC = Medium Complex
SC = Strong Complex

As shown in Table 2, no gel breaking retardation was observed using oxidizing breaker retarder with less than 20 moles EO or more than 40 moles EO regardless of the degree of esterification. The samples of Sorbitol with 30 moles EO and then esterified with 2-4 moles of oleic acid showed the maximum oxidizing breaker retardation in the crosslinked gel system.

Similar results to those obtained with oleic acid were found when tall oil fatty acid, lauric acid, and stearic acid were used instead of oleic acid indicating that the fatty acid used to esterify the polyalkoxylated sorbitol was not as critical as the degree of alkoxylation and esterification.

Conclusions

The partially esterified, polyalkoxylated polyols can be used as oxidizing breaker retarders in aqueous gelled fracturing systems. They moderate the effect of the oxidizing breaker(s) according to their concentrations, the well treating conditions and also by varying the degree of esterification and the degree of alkoxylation of the product. The inclusion of partially esterified, polyalkoxylated polyols in aqueous fracturing fluid compositions containing an oxidizing breaker and the fracturing of subterranean reservoirs using such formulations can better control the gel breaking time and optimize the treatment results.

Although the description above contains many specifics these should not be construed as limiting the scope of the invention but as merely providing illustrations of some of the presently preferred embodiments of this invention. Various other embodiments and ramifications are possible within it's scope. For example, other acids such as stearic, lauric and tall oil fatty acids may be used. Alkoxylates may be formed using ethylene oxide and propylene oxide, ethylene oxide and butylene oxide or ethylene oxide and both butylene and propylene oxide, in various proportions. Other polyols such as glycerine, polyglycerine, glucose, fructose, sucrose, pentaerythritol, trimethylolpropane, and polymers of ethylene oxide and propylene oxide may be used.

Thus the scope of the invention should be determined by the appended claims and their legal equivalents, rather than by the examples given.

What is claimed is:

1. A process for fracturing a subterranean reservoir by:
a) injecting into said reservoir a composition having delayed gel breaking properties and consisting of a hydratable gelling agent, an aqueous liquid, an oxidizing breaker, a partially esterified polyalkoxylated polyol as oxidizing breaker retarder, a proppant and optionally a pH control agent and crosslinking agent,
b) allowing enough time for the gel to break, and
c) allowing the broken gel to flow back out of the reservoir while leaving the proppant behind to keep the fracture open.

2. The process for fracturing a subterranean reservoir as described in claim 1 where the hydratable gelling agent is a polysaccharide and derivatives thereof which contain one or more of the following monosaccharide units: galactose, mannose, glucoside, glucose, xylose, arabinose, fructose, glucuronic acid, pyranosyl sulfate.

3. The process for fracturing a subterranean reservoir as described in claim 1 where the hydratable gelling agent is a synthetic polymer or copolymer of one or more of the following: polyacrylate, polymethacrylate, polyacrylamide, maleic anhydride methylvinyl ether copolymers, polyvinyl alcohol, polyvinylpyrrolidone.

4. The process for fracturing a subterranean reservoir as described in claim 1 where the hydratable gelling agent is chosen from the group guar gum and derivatives thereof, locust bean gum, tara, konjak, tamarind, starch, cellulose and derivatives thereof, karaya, xanthan, tragacanth, carrageenan.

5. The process for fracturing a subterranean reservoir as described in claim 1 where the aqueous liquid is water, a sodium chloride brine solution, a potassium chloride solution, or water-alcohol mixtures.

6. The process for fracturing a subterranean reservoir as described in claim 1 where the oxidizing breaker is ammonium persulfate; sodium persulfate; potassium persulfate; sodium peroxide; sodium chlorite; sodium, lithium or calcium hypochlorite; potassium perphosphate or sodium perborate.

7. The process for fracturing a subterranean reservoir as described in claim 1 where the partially esterified polyalkoxylated polyol oxidizing breaker retarder where the partially esterified polyalkoxylated polyol oxidizing breaker retarder is a mono and higher ester of one or more chosen from the group alkoxylated Sorbitol, alkoxylated monosaccharides, alkoxylated disaccharides, alkoxylated glycerin, alkoxylated polyglycerine, alkoxylated pentaerythritol, alkoxylated trimethylolpropane.

8. The process for fracturing a subterranean reservoir as described in claim 1 where the partially esterified polyalkoxylated polyol is an alkoxylate containing ethylene oxide groups, propylene oxide groups, butylene oxide groups or combinations of one or more ethylene oxide groups, propylene oxide groups, butylene oxide groups that has then been partially esterified with one or more fatty acids.

9. The process for fracturing a subterranean reservoir as described in claim 1 where the proppant is chosen from sand, resin coated sand, synthetic ceramics, or spherical pellets of glass.

10. The process for fracturing a subterranean reservoir as described in claim 1 where the concentration and degree of esterification and alkoxylation of the partially esterified polyalkoxylated polyol is chosen to give the desired amount of delayed breaking of the gelled fracturing fluid.
